(19) United States
(12) Patent Application Publication
(10) Pub. No.: US 2005/0215447 A1
(43) Pub. Date: Sep. 29, 2005

(54) Method of removing soap-scum from hard surfaces

(76) Inventors: Marc Francois Theophile Evers, Strombeek-Bever (BE); Oreste Todini, Brussels (BE); Annick Julia Oscar Mertens, Bornem (BE)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 11/088,699

(22) Filed: Mar. 24, 2005

(30) Foreign Application Priority Data
Mar. 25, 2004 (EP) 04447075.5

(51) Int. Cl. C11D 1/00

(52) U.S. Cl. 510/238

(57) ABSTRACT

The present invention describes a method of removing soap scum from a hard-surface comprising the step of applying a liquid aqueous acidic composition onto the hard-surface, wherein the composition comprises phosphoric acid and a nonionic surfactant. The above composition when used according to the method of the present invention, exhibits improved cleaning performance on soap scum while delivering also excellent limescale removal performance.

### TECHNICAL FIELD

The present invention relates to liquid compositions for cleaning hard-surfaces. More specifically, the present is directed to an improved method of removing soap scum from hard-surfaces typically found in a kitchen or in a bathroom.

### BACKGROUND OF THE INVENTION

Liquid compositions for cleaning hard-surfaces have been disclosed in the art. Much of the focus for such compositions has been on providing outstanding cleaning on a variety of soils and surfaces. Indeed, tap water contains a certain amount of solubilized ions which upon water evaporation eventually deposit as salts such as calcium carbonate on hard-surfaces which are often in contact with water, resulting in an anesthetic aspect of the surfaces. This limescale formation and deposition phenomenon is even more acute in places where water is particularly hard.

It is well-known in the art that limescale deposits can be chemically removed with acidic solutions. However, liquid acidic limescale removal compositions described in the art do not perform equally well on all limescale-containing stains, particularly on limescale-containing stains which can be found in bathrooms or in kitchens, i.e., on stains containing mineral deposits like calcium carbonate but also high amount of organic deposits such as greasy soap scum. Indeed, the presence of such greasy soap scum is detrimental to the limescale removal performance of acidic compositions.

There is a constant strive for the development of cleaning compositions with better performance in several respects including improved soap scum cleaning performance and excellent limescale removal performance.

Therefore, the objective of the present invention is to provide a method of removing soap scum from hard-surfaces, said method providing improved soap scum cleaning performance while delivering also excellent limescale removal performance.

It has now been surprisingly found that the above objective is met by providing a method of removing soap scum from a hard-surface comprising the step of applying a liquid aqueous acidic composition onto the hard-surface, wherein the composition comprises phosphoric acid and a nonionic surfactant.

Furthermore, the method of removing soap scum from hard-surfaces of the present invention, is based on a composition which is advantageously less complex than soap scum cleaning compositions described in the art and thus substantially cheaper in its formulation, while delivering outstanding soap scum removal and excellent limescale removal performance. In the context of the present invention, it has been further discovered that the presence of cationic surfactants, especially quaternary ammonium-based surfactants, in the composition of the present invention, may have a highly detrimental impact with respect to soap scum removal performance.

It is another advantage of the present invention to provide a method of removing soap scum from hard-surfaces based on a composition which is safe to consumers and not damaging to the treated surface, especially delicate surface such as linoleum, glass, plastic, plastified wood, metal or varnished surfaces.

Further advantages and more specific properties of the compositions of the present invention, will become clear after reading the following description of the invention.

### BACKGROUND ART

U.S. Pat. No. 4,587,030 discloses an acidic cleaning composition comprising a mixture of a weak inorganic acid (e.g. phosphoric or sulfamic acid) and a weak organic acid, a surfactant system comprising a major proportion of a cationic amine oxide surfactant, and a cosolvent.

U.S. Pat. No. 6,121,219 describes an acidic cleaning composition suitable for removing carbohydrate and proteinaceous soils, the composition comprising phosphoric acid, an organic carboxylic acid, a specific solvent, a phosphonate sequestrant, and a quaternary amine composition.

U.S. Pat. No. 5,935,921 discloses a limescale cleaning composition comprising phosphoric acid, an amino trialkyl phosphonic acid, an amine oxide, a cationic surfactant and an alkanol.

All the above-cited documents which at the most simply mention the possibility of incorporating nonionic surfactants in the compositions, clearly fail to recognize the critical importance of the combination of a nonionic surfactant and phosphoric acid while trying to achieve improved soap scum removal.

### SUMMARY OF THE INVENTION

The present invention relates to a method of removing soap scum from a hard-surface comprising the step of applying a liquid aqueous acidic composition onto the hard-surface, wherein the composition comprises phosphoric acid a nonionic surfactant.

In a preferred embodiment of the present invention, it is provided a method of removing soap scum from a hard-surface as described above, wherein the composition is free of cationic surfactants, preferably free of quaternary ammonium-based surfactants.

In a further aspect, the present invention relates to the use, in a composition suitable for removing soap scum from a hard-surface, of a combination of a nonionic surfactant and phosphoric acid, to improve the soap scum cleaning performance of the composition.

### DETAILED DESCRIPTION OF THE INVENTION

In first embodiment, the present invention relates a method of removing soap scum from a hard-surface comprising the step of applying a liquid aqueous acidic composition onto the hard-surface, wherein the composition comprises phosphoric acid and a nonionic surfactant.

The Liquid Aqueous Acidic Composition

The compositions according to the present invention are designed as hard-surfaces cleaners, preferred hard-surfaces treated therewith are those located in a bathroom or in a kitchen.

The liquid compositions are aqueous compositions. Therefore, they typically comprise from 70% to 99% by weight of the total composition of water, preferably from 75% to 95% and more preferably from 80% to 95%.

Moreover, the compositions of the present invention being acidic, they preferably have a pH below 7, preferably from 0 to 6, more preferably from 0.1 to 5, most preferably from 3 to 4.5.

Phosphoric Acid

According to the present invention, the composition comprises phosphoric acid. The amount of phosphoric acid herein may vary depending on the amount of other ingredients, however the composition of the present invention may comprise up to 25% by weight of the total composition, preferably from 1% to 25%, more preferably from 5% to 20%, even more preferably from 10% to 17%, most preferably from 14% to 16% of phosphoric acid. Phosphoric acid may be purchased from J. T. Baker.

Nonionic Surfactant

The compositions of the present invention additionally comprise a nonionic surfactant, or a mixture thereof, as another essential ingredient.

Suitable nonionic surfactants for use herein are alkoxylated alcohol nonionic surfactants which can be readily made by condensation processes which are well-known in the art. However, a great variety of such alkoxylated alcohols, especially ethoxylated and/or propoxylated alcohols is also conveniently commercially available. Surfactants catalogs are available which list a number of surfactants, including nonionics.

Accordingly, preferred alkoxylated alcohols for use herein are nonionic surfactants according to the formula RO(E)e(P)pH where R is a hydrocarbon chain of from 2 to 24 carbon atoms, E is ethylene oxide and P is propylene oxide, and e and p which represent the average degree of, respectively ethoxylation and propoxylation, are of from 0 to 24. The hydrophobic moiety of the nonionic compound can be a primary or secondary, straight or branched alcohol having from 8 to 24 carbon atoms.

Preferred nonionic surfactants for use in the compositions according to the invention are the condensation products of ethylene oxide with alcohols having a straight alkyl chain, having from 6 to 22 carbon atoms, wherein the degree of ethoxylation is from 1 to 15, preferably from 5 to 12. Such suitable nonionic surfactants are commercially available from Shell, for instance, under the trade name Dobanol® or from BASF under the trade name Lutensol®.

The compositions of the present invention may comprise up to 15% by weight of the total composition of a nonionic surfactant or a mixture thereof, preferably from 0.1% to 15%, more preferably from 1% to 10%, even more preferably from 1% to 5%, and most preferably from 2% to 3%.

In a preferred embodiment of the present invention, the composition comprises at least 1% by weight of the total composition of a nonionic surfactant or mixture thereof.

It has now been surprisingly discovered that a liquid aqueous acidic composition comprising phosphoric acid and a nonionic surfactant provides outstanding performances in terms of soap scum removal from a hard-surface. According to the present invention, such a remarkable performance is due to a highly and unexpected synergetic effect between phosphoric acid and a nonionic surfactant.

Optional Ingredients

The compositions according to the present invention may comprise a variety of optional ingredients depending on the technical benefit aimed for and the surface treated.

Suitable optional ingredients for use herein include homo or copolymers of vinylpyrrolidone, polysaccharide polymers, chelating agents, radical scavengers, perfumes, solvents, other surfactants, acids, builders, buffers, bactericides, hydrotropes, colorants, stabilizers, bleaches, bleach activators, suds controlling agents like fatty acids, enzymes, soil suspenders, dye transfer agents, brighteners, anti dusting agents, dispersants, dye transfer inhibitors, pigments, caustic, dyes.

Chelating Agent

The compositions of the present invention may comprise chelating agents or mixtures thereof. Chelating agents can be incorporated in the compositions herein in amounts ranging from 0% to 10% by weight of the total composition, preferably 0.01% to 5.0%, more preferably 0.05% to 1%.

Suitable phosphonate chelating agents to be used herein may include alkali metal ethane 1-hydroxy diphosphonates (HEDP), alkylene poly (alkylene phosphonate), as well as amino phosphonate compounds, including amino aminotri(methylene phosphonic acid) (ATMP), nitrilo trimethylene phosphonates (NTP), ethylene diamine tetra methylene phosphonates, and diethylene triamine penta methylene phosphonates (DTPMP). The phosphonate compounds may be present either in their acid form or as salts of different cations on some or all of their acid functionalities.

Preferred chelating agents to be used herein are diethylene triamine penta methylene phosphonate (DTPMP) and ethane 1-hydroxy diphosphonate (HEDP). In a particularly preferred execution of the present invention, the chelating agent is selected to be ethane 1-hydroxy diphosphonate (HEDP). Such phosphonate chelating agents are commercially available from Monsanto under the trade name DEQUEST®.

Polyfunctionally-substituted aromatic chelating agents may also be useful in the compositions herein. See U.S. Pat. No. 3,812,044, issued May 21, 1974, to Connor et al. Preferred compounds of this type in acid form are dihydroxydisulfobenzenes such as 1,2-dihydroxy -3,5-disulfobenzene.

A preferred biodegradable chelating agent for use herein is ethylene diamine N,N′-disuccinic acid, or alkali metal, or alkaline earth, ammonium or substitutes ammonium salts thereof or mixtures thereof. Ethylenediamine N,N′-disuccinic acids, especially the (S,S) isomer have been extensively described in U.S. Pat. No. 4,704,233, Nov. 3, 1987, to Hartman and Perkins. Ethylenediamine N,N′-disuccinic acids is, for instance, commercially available under the tradename ssEDDS® from Palmer Research Laboratories.

Suitable amino carboxylates to be used herein include ethylene diamine tetra acetates, diethylene triamine pentaacetates, diethylene triamine pentaacetate (DTPA),N-hydroxyethylethylenediamine triacetates, nitrilotri-acetates, ethylenediamine tetrapropionates, triethylenetetraaminehexa-acetates, ethanol-diglycines, propylene diamine tetracetic acid (PDTA) and methyl glycine di-acetic acid (MGDA), both in their acid form, or in their alkali metal, ammonium, and substituted ammonium salt forms. Particularly suitable amino carboxylates to be used herein are diethylene triamine penta acetic acid, propylene diamine tetracetic acid (PDTA) which is, for instance, commercially available from BASF under the trade name Trilon FS® and methyl glycine di-acetic acid (MGDA).

Further carboxylate chelating agents to be used herein include salicylic acid, aspartic acid, glutamic acid, glycine, malonic acid or mixtures thereof.

Vinvlpyrrolidone Homopolymer or Copolymer

The aqueous acidic compositions of the present invention may optionally comprise a vinylpyrrolidone homopolymer or copolymer, or a mixture thereof. Typically, the compositions of the present invention may comprise from 0.01% to 5% by weight of the total composition of a vinylpyrrolidone homopolymer or copolymer, or a mixture thereof, more preferably from 0.05% to 3% and most preferably from 0.05% to 1%.

Suitable vinylpyrrolidone homopolymers for use herein are homopolymers of N-vinylpyrrolidone having the following repeating monomer: 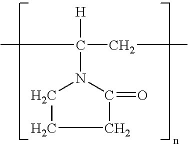
wherein n (degree of polymerisation) is an integer of from 10 to 1,000,000, preferably from 20 to 100,000, and more preferably from 20 to 10,000.

Accordingly, suitable vinylpyrrolidone homopolymers (“PVP”) for use herein have an average molecular weight of from 1,000 to 100,000,000, preferably from 2,000 to 10,000,000, more preferably from 5,000 to 1,000,000, and most preferably from 50,000 to 500,000.

Suitable vinylpyrrolidone homopolymers are commercially available from ISP Corporation, New York, N.Y. and Montreal, Canada under the product names PVP K-15® (viscosity molecular weight of 10,000), PVP K-30® (average molecular weight of 40,000), PVP K-60® (average molecular weight of 160,000), and PVP K-90® (average molecular weight of 360,000). Other suitable vinylpyrrolidone homopolymers which are commercially available from BASF Cooperation include Sokalan HP 165®, Sokalan HP 12®, Luviskol K30®, Luviskol K60®, Luviskol K80®, Luviskol K90®; vinylpyrrolidone homopolymers known to persons skilled in the detergent field (see for example EP-A-262,897 and EP-A-256,696).

Suitable copolymers of vinylpyrrolidone for use herein include copolymers of N-vinylpyrrolidone and alkylenically unsaturated monomers or mixtures thereof.

The alkylenically unsaturated monomers of the copolymers herein include unsaturated dicarboxylic acids such as maleic acid, chloromaleic acid, fumaric acid, itaconic acid, citraconic acid, phenylmaleic acid, aconitic acid, acrylic acid, N-vinylimidazole and vinyl acetate. Any of the anhydrides of the unsaturated acids may be employed, for example acrylate, methacrylate. Aromatic monomers like styrene, sulphonated styrene, alpha-methyl styrene, vinyl toluene, t-butyl styrene and similar well known monomers may be used.

For example particularly suitable N-vinylimidazole N-vinylpyrrolidone polymers for use herein have an average molecular weight range from 5,000 to 1,000,000, preferably from 5,000 to 500,000, and more preferably from 10,000 to 200,000. The average molecular weight range was determined by light scattering as described in Barth H. G. and Mays J. W. Chemical Analysis Vol 113, “Modern Methods of Polymer Characterization”.

Such copolymers of N-vinylpyrrolidone and alkylenically unsaturated monomers like PVP/vinyl acetate copolymers are commercially available under the trade name Luviskol® series from BASF.

According to a very preferred execution of the present invention, vinylpyrrolidone homopolymers are advantageously selected.

Polysaccharide Polymer

The compositions of the present invention may optionally comprise a polysaccharide polymer or a mixture thereof. Typically, the compositions of the present invention may comprise from 0.01% to 5% by weight of the total composition of a polysaccharide polymer or a mixture thereof, more preferably from 0.05% to 3% and most preferably from 0.05% to 1%.

Suitable polysaccharide polymers for use herein include substituted cellulose materials like carboxymethylcellulose, ethyl cellulose, hydroxyethyl cellulose, hydroxypropyl cellulose, hydroxymethyl cellulose, succinoglycan and naturally occurring polysaccharide polymers like xanthan gum, guar gum, locust bean gum, tragacanth gum or derivatives thereof, or mixtures thereof.

Particularly polysaccharide polymers for use herein are xanthan gum and derivatives thereof. Xanthan gum and derivatives thereof may be commercially available for instance from Kelco under the trade name Keltrol RD®, Kelzan S® or Kelzan T®. Other suitable Xanthan gum are commercially available by Rhone Poulenc under the trade name Rhodopol T®0 and Rhodigel X747®. Succinoglycan gum for use herein is commercially available by Rhone Poulenc under the trade name Rheozan®.

Without intended to be bound by theory, it has been shown that vinylpyrrolidone homopolymers or copolymers, preferably the vinylpyrrolidone homopolymer, and polysaccharide polymers, preferably xanthan gum or derivatives thereof, described herein, when added into an aqueous acidic composition deliver improved shine to the treated surface as well as improved next-time cleaning benefit on said surface, while delivering good first-time hard-surface cleaning performance and good limescale removal performance. Furthermore, the formation of watermarks and/or limescale deposits upon drying is reduced or even eliminated.

Moreover, the vinylpyrrolidone homopolymers or copolymers and polysaccharide polymers further provide long lasting protection against formation of watermarks and/or deposition of limescale deposits, hence, long lasting shiny surfaces.

An additional advantage related to the use of the vinylpyrrolidone homopolymers or copolymers and polysaccharide polymers, in the acidic compositions herein, is that as they adhere on hard surface making them more hydrophilic, the surfaces themselves become smoother (this can be perceived by touching said surfaces) and this contributes to convey perception of surface perfectly descaled.

Advantageously, these benefits are obtained at low levels of vinylpyrrolidone homopolymers or copolymers and polysaccharide polymers, preferably xanthan gum or derivatives thereof, described herein, thus it is yet another advantage of the present invention to provide the desired benefits at low cost.

Radical Scavenger

The compositions of the present invention may further comprise a radical scavenger or a mixture thereof.

Suitable radical scavengers for use herein include the well-known substituted mono and dihydroxy benzenes and their analogs, alkyl and aryl carboxylates and mixtures thereof. Preferred such radical scavengers for use herein include di-tert-butyl hydroxy toluene (BHT), hydroquinone, di-tert-butyl hydroquinone, mono-tert-butyl hydroquinone, tert-butyl-hydroxy anysole, benzoic acid, toluic acid, catechol, t-butyl catechol, benzylamine, 1,1,3-tris(2-methyl-4-hydroxy-5-t-butylphenyl)butane, n-propyl-gallate or mixtures thereof and highly preferred is di-tert-butyl hydroxy toluene. Such radical scavengers like N-propyl-gallate may be commercially available from Nipa Laboratories under the trade name Nipanox S1®.

Radical scavengers when used, may be typically present herein in amounts up to 10% by weight of the total composition and preferably from 0.001% to 0.5% by weight. The presence of radical scavengers may contribute to the chemical stability of the compositions of the present invention.

Perfume

Suitable perfume compounds and compositions for use herein are for example those described in EP-A-0957156 under the paragraph entitled “Perfume” in page 13.

The compositions herein may comprise a perfume ingredient, or mixtures thereof, in amounts up to 5.0% by weight of the total composition, preferably in amounts of 0.1% to 1.5%.

Solvent

The compositions of the present invention may further comprise a solvent or a mixture thereof, as an optional ingredient. Solvents to be used herein include all those known to those skilled in the art of hard-surfaces cleaner compositions.

Solvents are desired herein because they contribute to the greasy soap scum cleaning of the composition herein, they also improve the wettability of the surfaces being treated with said composition to maximize the polymers adsorption on the treated surface, with consequent improved sheeting effect and therefore even enhances the advantages of the present invention, described herein.

Suitable solvents for use herein include ethers and diethers having from 4 to 14 carbon atoms, preferably from 6 to 12 carbon atoms, and more preferably from 8 to 10 carbon atoms, glycols or alkoxylated glycols, alkoxylated aromatic alcohols, aromatic alcohols, aliphatic branched alcohols, alkoxylated aliphatic branched alcohols, alkoxylated linear C1-C5 alcohols, linear C1-C5 alcohols, C8-C14 alkyl and cycloalkyl hydrocarbons and halohydrocarbons, C6-C16 glycol ethers and mixtures thereof.

Typically, the compositions of the present invention may comprise from 0.1% to 5% by weight of the total composition of a solvent or mixtures thereof, preferably from 0.5% to 5% by weight of the total composition and more preferably from 1% to 3% by weight of the total composition.

Additional Surfactant

The compositions of the present invention may comprise an additional surfactant, or mixtures thereof, on top of the nonionic surfactant already described herein. Additional surfactants may be desired herein as they may further contribute to the cleaning performance and/or shine benefit of the compositions of the present invention. Surfactants to be used herein include anionic surfactants, amphoteric surfactants, zwitterionic surfactants, and mixtures thereof.

Accordingly, the compositions according to the present invention may comprise up to 15% by weight of the total composition of another surfactant or a mixture thereof, on top of the anionic surfactant already described herein, more preferably from 0.5% to 5%, even more preferably from 0.5% to 3%, and most preferably from 0.5% to 2%. Different surfactants may be used in the present invention including anionic, cationic, zwitterionic or amphoteric surfactants. It is also possible to use mixtures of such surfactants without departing from the spirit of the present invention.

Preferred surfactants for use herein are anionic and zwitterionic surfactants since they provide excellent grease soap scum cleaning ability to the compositions of the present invention.

Anionic surfactants may be included herein as they contribute to the cleaning benefits of the hard-surface cleaning compositions of the present invention. Indeed, the presence of an anionic surfactant contributes to the greasy soap scum cleaning of the compositions herein. More generally, the presence of an anionic surfactant in the liquid acidic compositions according to the present invention allows to lower the surface tension and to improve the wettability of the surfaces being treated with the liquid acidic compositions of the present invention. Furthermore, the anionic surfactant, or a mixture thereof, helps to solubilize the soils in the compositions of the present invention.

Suitable anionic surfactants for use herein are all those commonly known by those skilled in the art. Preferably, the anionic surfactants for use herein include alkyl sulphonates, alkyl aryl sulphonates, or mixtures thereof.

Particularly suitable liner alkyl sulphonates include C12-C16 paraffin sulphonate like Hostapur® SAS commercially available from Hoechst.

Other anionic surfactants useful herein include salts (including, for example, sodium, potassium, ammonium, and substituted ammonium salts such as mono-, di- and triethanolamine salts) of soap, C₈-C₂₄ olefinsulfonates, sulphonated polycarboxylic acids prepared by sulphonation of the pyrolyzed product of alkaline earth metal citrates, e.g., as described in British patent specification No. 1,082,179; alkyl ester sulfonates such as C₁₄₋₁₆ methyl ester sulfonates; acyl glycerol sulfonates, alkyl phosphates, isethionates such as the acyl isethionates, N-acyl taurates, alkyl succinamates, acyl sarcosinates, sulfates of alkylpolysaccharides such as the sulfates of alkylpolyglucoside (the nonionic nonsulfated compounds being described below), alkyl polyethoxy carboxylates such as those of the formula RO(CH₂CH₂O)ₖCH₂COO-M⁺ wherein R is a C₈-C₂₂ alkyl, k is an integer from 0 to 10, and M is a soluble salt-forming cation. Resin acids and hydrogenated resin acids are also suitable, such as rosin, hydrogenated rosin, and resin acids and hydrogenated resin acids present in or derived from tall oil. Further examples are given in “Surface Active Agents and Detergents” (Vol. I and II by Schwartz, Perry and Berch). A variety of such surfactants are also generally disclosed in U.S. Pat. No. 3,929,678, issued Dec. 30, 1975 to Laughlin, et al. at Column 23, line 58 through Column 29, line 23.

Suitable zwitterionic surfactants for use herein contain both basic and acidic groups which form an inner salt giving both cationic and anionic hydrophilic groups on the same molecule at a relatively wide range of pH's. The typical cationic group is a quaternary ammonium group, although other positively charged groups like phosphonium, imidazolium and sulfonium groups can be used. The typical anionic hydrophilic groups are carboxylates and sulfonates, although other groups like sulfates, phosphonates, and the like can be used.

Common examples of zwitterionic surfactants(i.e. betaine/sulphobetaine) are described in U.S. Pat. Nos. 2,082,275, 2,702,279 and 2,255,082, incorporated herein by reference.

Examples of particularly suitable alkyldimethyl betaines include coconut-dimethyl betaine, lauryl dimethyl betaine, decyl dimethyl betaine, 2-(N-decyl-N,N-dimethyl-ammonia)acetate, 2-(N-coco N,N-dimethylammonio) acetate, myristyl dimethyl betaine, palmityl dimethyl betaine, cetyl dimethyl betaine, stearyl dimethyl betaine. For example Coconut dimethyl betaine is commercially available from Seppic under the trade name of Amonyl 265®. Lauryl betaine is commercially available from Albright & Wilson under the trade name Empigen BB/L®.

A further example of betaine is Lauryl-immino-dipropionate commercially available from Rhone-Poulenc under the trade name Mirataine H2C-HA®.

Particularly preferred zwitterionic surfactants for use in the compositions of the present invention are the sulfobetaine surfactants as they deliver optimum soap scum cleaning benefits.

Examples of particularly suitable sulfobetaine surfactants include tallow bis(hydroxyethyl) sulphobetaine, cocoamido propyl hydroxy sulfobetaines which are commercially available from Rhone Poulenc and Witco, under the trade name of Mirataine CBS® and Rewoteric AM CAS 15® respectively.

Suitable amines for use herein are for instance C12 dimethyl amine, coconut dimethyl amine, C12-C16 dimethyl amine. Said amines may be commercially available from Hoechst under the trade name Genamin®, AKZO under the trade name Aromox® or Fina under the trade name Radiamine®.

Amphoteric and ampholytic detergents which can be either cationic or anionic depending upon the pH of the system are represented by detergents such as dodecylbeta-alanine, N-alkyltaurines such as the one prepared by reacting dodecylamine with sodium isethionate according to the teaching of U.S. Pat. No. 2,658,072, N-higher alkylaspartic acids such as those produced according to the teaching of U.S. Pat. No. 2,438,091, and the products sold under the trade name “Miranol”, and described in U.S. Pat. No. 2,528,378, said patents being incorporated herein by reference. Additional synthetic detergents and listings of their commercial sources can be found in McCutcheon's Detergents and Emulsifiers, North American Ed. 1980, incorporated herein by reference.

Suitable amphoteric surfactants include the amine oxides. Examples of amine oxides for use herein are for instance coconut dimethyl amine oxides, C12-C16 dimethyl amine oxides. Said amine oxides may be commercially available from Hoechst, Stephan, AKZO (under the trade name Aromox®) or FINA (under the trade name Radiamox®). Other suitable amphoteric surfactants for the purpose of the invention are the phosphine or sulfoxide surfactants.

In the context of the present invention, it has been surprisingly discovered that the presence of cationic surfactants, in particular quaternary ammonium-based surfactants, in the composition according to the present invention may be highly detrimental to the soap scum removal performance.

Without wishing to be bound by theory, it is further believed that the addition of cationic surfactants in the compositions of the present invention may be detrimental with respect of specific benefits which are generally pursued while formulating a cleaning composition. In particular, it is believed that lower performances may be obtained in terms of easy rinsing, resulting shine. Moreover, the presence of the above-mentioned surfactants in the cleaning composition of the present invention may lead to formation of higher amount of suds and streaks on the treated surface.

Accordingly, in a preferred execution, the composition of the present invention is free of cationic surfactants, preferably free of quaternary ammonium-based surfactants.

Dye

The compositions according to the present invention may be coloured. Accordingly, they may comprise a dye or a mixture thereof. Suitable dyes for use herein are acid-stable dyes. By “acid-stable”, it is meant herein a compound which is chemically and physically stable in the acidic environment of the compositions herein.

Caustic

In order to maintain the pH of the composition herein disclosed, the composition may further comprise a caustic or a mixture thereof, as an optional ingredient. Caustic to be used herein include all those known to those skilled in the art of hard-surfaces cleaner compositions, as hydroxides of metals, ammonia, and the like. A preferred caustic is NaOH.

Acids

The compositions of the present invention may optionally comprise an acid, or, mixtures thereof in addition to phosphoric acid. Acids to be used herein include all those known to those skilled in the art of hard-surfaces cleaner compositions. Preferably, acids for use herein are weak organic acids. Suitable weak organic acids include formic acid, citric acid, maleic acid, lactic acid, glycolic acid, succinic acid, glutaric acid, oxalic acid, and mixtures thereof.

The Method of Removing Soap Scum from a Hard-Surface

The present invention relates to a method of removing soap scum from a hard-surface comprising the step of applying a liquid aqueous acidic composition onto the hard-surface, wherein the composition comprises phosphoric acid a nonionic surfactant.

By “hard-surface”, it is meant herein any kind of surfaces typically found in houses like bathrooms, kitchens, or in car interiors or exteriors, e.g., floors, walls, tiles, windows, sinks, showers, shower plastified curtains, wash basins, WCs, dishes, fixtures and fittings and the like made of different materials like ceramic, vinyl, no-wax vinyl, linoleum, melamine, glass, any plastics, plastified wood, metal or any painted or varnished or sealed surface and the like. The term surfaces as used herein also include household appliances including, but not limited to, washing machines, automatic dryers, refrigerators, freezers, ovens, microwave ovens, dishwashers and so on.

Although the compositions of the present invention comprise phosphoric acid, it has been surprisingly found that a wide range of surfaces including metal surfaces such as aluminium, chromed steel or stainless steel, may be treated with the above-mentioned compositions without said surfaces being damaged or corroded.

The preferred method of removing soap scum from a hard-surface comprises the step of applying a liquid aqueous acidic composition as described above onto said hard-surface, leaving said composition on said hard-surface to act, optionally wiping said hard-surface with an appropriate instrument, e.g. a sponge, and then preferably rinsing said hard-surface with water.

The compositions of the present invention may be contacted to the hard-surface to be treated in its neat form or in its diluted form. Preferably, the composition is applied in its neat form.

By “diluted form”, it is meant herein that said composition is diluted by the user typically with water. The composition is diluted prior use to a typical dilution level of 10 to 400 times its weight of water, preferably from 10 to 200 and more preferably from 10 to 100. Usual recommended dilution level is a 1.2% dilution of the composition in water.

The method according to the present invention is suitable for treating hard-surfaces located in bathrooms or in kitchens, and particularly in bathrooms. These bathroom surfaces may be soiled by the so called “limescale-containing stains”. By “limescale-containing stains” it is meant herein any pure limescale stains, i.e., any stains composed essentially of mineral deposits, as well as limescale-containing stains, i.e., stains which contain not only mineral deposits like calcium and/or magnesium carbonate but also soap scum (e.g., calcium stearate) and other grease (e.g. body grease). Actually, the method of the present invention enables achieving excellent limescale removing performance when used to treat any types of surfaces soiled by limescale-containing stains comprising not only pure limescale deposits but also at least 10% by weight of the total stain of organic deposits like soap scum and grease, preferably more than 30%. The method of the present invention provides particularly improved cleaning performance on soap scum stains, and especially on greasy soap scum stains.

In a further aspect, the present invention relates to the use, in a composition suitable for removing soap scum from a hard-surface, of a combination of a nonionic surfactant and phosphoric acid, to improve the soap scum cleaning performance of the composition.

Greasy Soap Scum Cleaning Performance Test Method:

In this test method enamel white tiles (typically 24 cm×4 cm) are covered with typical greasy soap scum soils mainly based on calcium stearate and artificial body soils commercially available (e.g. 0.3 grams with a sprayer). The soiled tiles are then dried in an oven at a temperature of 140° C. for 20 minutes and then aged overnight at room temperature (around 20° C.-25° C.). Then the soiled tiles are cleaned using 3 ml of the composition of the present invention poured directly on a Spontex® sponge. The ability of the composition to remove greasy soap scum is measured through the number of stroke cycles needed to perfectly clean the surface. The lower the number of stroke cycles, the higher the greasy soap scum cleaning ability of the composition.

### EXAMPLES

These following compositions were made comprising the listed ingredients in the listed proportions (weight %). The examples herein are met to exemplify the present invention but are not necessarily used to limit or otherwise define the scope of the present invention. Compositions I to VI are compositions according to the present invention, whereas compositions VII-VIII are comparative examples. Composition IX represents a reference composition.

| Ingredients: | | | | | | | | | |
|---|---|---|---|---|---|---|---|---|---|
| (% by weight) | I | II | III | IV | V | VI | VII | VIII | IX |
| Phosphoric acid | 15 | 15 | 12 | 20 | 20 | 15 | 15 | 15 | — |
| Maleic acid | — | — | — | — | — | — | — | — | 9 |
| Sulfamic acid | — | — | — | — | — | — | — | — | 2 |
| Dobanol 91-8 | 2.2 | 1.0 | 2.2 | 2.0 | 1.0 | 2.0 | — | 1.0 | 2.2 |
| Luviskol K60 ® | 0.05 | 0.05 | 0.1 | — | — | — | 0.05 | 0.05 | 0.05 |
| Kelzan T ® | 0.28 | 0.28 | 0.28 | 0.28 | 0.28 | — | 0.28 | 0.28 | 0.3 |
| Quaternary | — | — | — | — | — | — | 2.2 | 0.1 | — |
| ammonium | | | | | | | | | |

| | |
|---|---|
| Waters & Minors | Up to 100 |

The pH of these examples is below 7.
Phosphoric acid is purchased from J. T. Baker.
HEDP is a chelating agent supplied by Monsanto
Dobanol 91-8 is an ethoxylated alcohol nonionic surfactant supplied by Shell.
Kelzan T ® is a Xanthan gum supplied by Kelco.
Luviskol K60 ® is a Polyvinylpyrrolidone supplied by BASF.
Quaternary ammonium is hexadecyl trimethyl ammonium chloride available from Aldrich.

Compositions I to VI exhibit outstanding cleaning performance on greasy soap scum, and provide excellent limescale removal performance.

### COMPARATIVE DATA

A comparative greasy soap scum removal performance study was conducted according to the test method as previously described. The study involved two compositions according to the present invention (Examples I and II), two comparative compositions (Examples VII and VIII), and a reference composition (Example IX). For all five compositions, the number of stroke cycles needed to perfectly clean the surface was measured. Performance on greasy soap scum removal was evaluated for each of the four exemplified compositions (Examples I, II, VII and VIII) with respect to the reference composition. The corresponding performances were expressed in terms of Cleaning index, which was calculated according to the following formula:
Cleaning index (CI)=(NS₁/NS₂)×100
Where NS₁=number of stroke cycles needed for the reference composition (Ex. IX).

NS₂=number of stroke cycles needed for the tested composition.

| Greasy soap | | Ex- | | | |
|---|---|---|---|---|---|
| scum | | ample | Example | Example | Example |
| Cleaning Test | Example I | II | VII | VIII | IX (Ref.) |
| Cleaning | 218 | 143 | <55 | 45 | 100 |
| index | | | | | |

The above results clearly show the improved soap scum removal performance obtained with compositions according to the present invention (e.g. composition I), i.e. compositions comprising a nonionic surfactant in combination with phosphoric acid, versus comparative compositions comprising a cationic surfactant (e.g. a quaternary ammonium) on top of phosphoric acid. Furthermore, it is clearly apparent from the above results that the inclusion of quaternary ammonium-based surfactants in the acidic compositions according to the present invention, is highly detrimental to the soap scum removal performance.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A method of removing soap scum from a hard-surface comprising the step of applying a liquid aqueous acidic composition onto said hard-surface, wherein said composition comprises phosphoric acid and a nonionic surfactant.

2. The method according to claim 1, wherein said phosphoric acid comprises from about 1% to about 25% by weight of the composition.

3. The method according to claim 2, wherein said phosphoric acid comprises from about 10% to about 17% by weight of the composition.

4. The method according to claim 1, wherein said nonionic surfactant is a condensation product of ethylene oxide with an alcohol having a straight alkyl chain comprising from about 6 to about 22 carbon atoms and wherein the degree of ethoxylation is from about 1 to about 15 or mixtures thereof.

5. The method according to claim 1, wherein said nonionic surfactant comprises from about 0.1% to about 15% by weight of the composition.

6. The method according to claim 5, wherein said nonionic surfactant comprises from about 2% to about 3% by weight of the composition.

7. The method according to claim 1, wherein said nonionic surfactant comprises at least 1% by weight of the composition.

8. The method according to claim 1, wherein said composition has a pH from about 0 to about 6.

9. The method according to claim 1, wherein said composition is substantially free of cationic surfactants.

10. The method according to claim 9, wherein said composition is substantially free of quaternary ammonium-based surfactants.

11. The method according to claim 1 wherein said composition further comprises at least one member chosen from the group comprising homopolymer or copolymer of vinylpyrrolidone, polysaccharide polymer, chelating agent, anionic surfactant, amphoteric surfactant, zwitterionic surfactant, radical scavenger, caustic, perfume, dye, and mixtures thereof.

12. The method according to claim 1 further comprising the steps of leaving said composition on said hard-surface to act, optionally wiping said hard-surface, and rinsing said hard-surface.

13. The method according to claim 1 wherein said hard-surface is located in a bathroom or in a kitchen.

14. A method of using a combination of a nonionic surfactant and phosphoric acid, for improving the soap scum cleaning performance of a composition suitable for removing soap scum from a hard surface.
